(19) United States
(12) Patent Application Publication
(10) Pub. No.: US 2005/0173864 A1
(43) Pub. Date: Aug. 11, 2005

(54) Authorship cooperative system

(76) Inventor: Yongjun Zhao, Redwood, CA (US)

Correspondence Address: TONG & ASSOCIATES, 5850 ANOGA AVENUE, SUITE #400, WOODLAND HILLS, CA, 91367, US

(21) Appl. No.: 11/053,815

(22) Filed: Feb. 8, 2005

Related U.S. Application Data
(60) Provisional application No. 60/542,977, filed on Feb. 10, 2004.
(60) Provisional application No. 60/622,117, filed on Oct. 25, 2004.

(51) Int. Cl. A63F 1/00; G09B 5/00; G09B 3/00; G09B 7/00

(52) U.S. Cl. 273/299; 434/322; 434/169

(57) ABSTRACT

The present invention includes a method of composing at least one literary work. The method includes establishing a story theme; providing a plurality of interconnected computers; allowing users to use the plurality of interconnected computers; forming a cast of authors from the users of the plurality of interconnected computers; and allowing the cast of authors to compose a script based on the story theme.

### CROSS REFERENCE TO RELATED APPLICATIONS

This application claims the priority of U.S. provisional patent application Ser. No. 60/542,977 filed on Feb. 10, 2004 with the title “Authorship Cooperative System” and U.S. provisional patent application Ser. No. 60/622,117 filed on Oct. 25, 2004 with the title “Authorship Cooperative System.”

### FIELD OF THE INVENTION

The present invention relates to computer programs configured to process data and in particular, computer programs that allow computer users to work together to produce literary works.

### BACKGROUND

Literary works, such as plays, novels, and movie scripts, are traditionally created by an individual author who may use a typewriter or a word processing device, such as a computer. The author typically works in his house or office alone and spends a substantial amount of time composing the entire literary work. The author may derive the material he uses in his composition from his practical experience or personal perspective.

One problem with this traditional method is that it cannot effectively portray certain scenarios, especially those that require diverse perspectives. For instance, when producing a composition about a war, it is desirable to portray the war from the perspective, for example, of a soldier, a mother whose son is about to go to a war, a political leader, a child, a casualty, etcetera. Certainly, the author cannot possibly be the single source of all the above perspectives no matter how much experience, both in reality and in writing, the author may have.

While it is true that the author may compile other people's perspectives through research, such as by reading books in public libraries or by interviewing people whom the author believes possess the requisite experience and knowledge, such research may be time consuming and inefficient. For instance, the author may have to go through so many books before he can find the right one. The author may have to read the book over and over again to remember a certain perspective. The author may have to make copies of certain pages of the book or highlight the portion of the book. Even if the author learns about a certain perspective, his interpretation of said perspective may still be different from the real perspective.

Conducting research by interviewing people may also be inefficient. For instance, the author may be confronted with indifferent and uncooperative people. The author may also have to interview so many people and spend so much time before he can find the right person. The applicant believes that quality in literary works comes from the ability to effectively gather input from a variety of people from diverse backgrounds and the ability to effectively organize these inputs into a single composition. A system that facilitates the gathering and organization of said inputs is desired.

Another problem with the traditional method of script writing is that it may have a tendency to discourage people from writing scripts. Traditional script writing may be perceived by many as a daunting task because the author has to write the entire composition. Traditional script writing may further be perceived by many as requiring a highly specialized skill because the traditional author fills in the script of all the roles. Thus, people are not easily encouraged to produce literary works with the traditional method. It is desirable to make script writing less burdensome and easier than the traditional script writing so as to encourage more people to write literary works.

### SUMMARY

Brief Description

The present invention includes a method of composing at least one literary work. The method includes establishing a story theme; providing a plurality of interconnected computers; allowing users to use the plurality of interconnected computers; forming a cast of authors from the users of the plurality of interconnected computers; and allowing the cast of authors to compose a script based on the story theme.

The above description sets forth, rather broadly, a summary of the preferred embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of the authorship cooperative system of the present invention.

FIG. 2 is substantially a schematic view of one embodiment of the hierarchical structure of the components of a project goal of the present invention.

FIG. 3 is substantially a flowchart showing one embodiment of an invitation protocol of the present invention.

FIG. 4 is substantially a flowchart showing a protocol for allocating seats to potential cast members for a performance.

FIG. 5 is substantially a flowchart showing a protocol for coordinating potential cast members.

FIG. 6 is substantially a flowchart showing another embodiment of an invitation protocol of the present invention.

FIG. 7 is substantially a flowchart showing a protocol for granting performance access to selected cast members.

FIG. 8 is substantially a flowchart showing an embodiment of the assessment system of the present invention.

FIG. 9 is substantially a flowchart showing a protocol for soliciting cast member decisions on whether to publish a composition.

FIG. 10 is substantially a flowchart showing one embodiment of a protocol for closing a performance.

FIG. 11 is substantially a flowchart showing one embodiment of a protocol that allows a casting director or project initiator to find a cast member for a project.

FIG. 12 is substantially a flowchart showing yet another embodiment of an invitation col of the present invention.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

As used herein, the term “internet” may interchangeably be used with the term “network” to refer to a communication system that allows users to connect and transmit data between computers, terminals, or databases. The term “server” may interchangeably be used with the term “computer” to refer to an electronic device or a plurality of connected electronic devices that can store, retrieve, or process data or that can provide service for computers connected thereto. The terms “server” or “computer” are not limited by their physical location. A server or computer may be a home computer, an office computer, or a remotely accessible computer.

The term “literary work” may interchangeably be used with the terms “composition,” “novel,” “script,” “literature,” and “work of authorship” to refer to writings expressing ideas of universal interest. “Literary work” may include, but is not limited to, poems, music, movie script, drama script, plays, and the like. The term “author” may interchangeably be used with the term “composer,” “performer,” “player,” “subscriber,” and “writer” to refer to the person involved in producing the literary work. The term “performance” may interchangeably be used with the term “theater” to refer to a stage in the program where the cast has been selected and is about to or is in the process of writing at least a portion of the literary work.

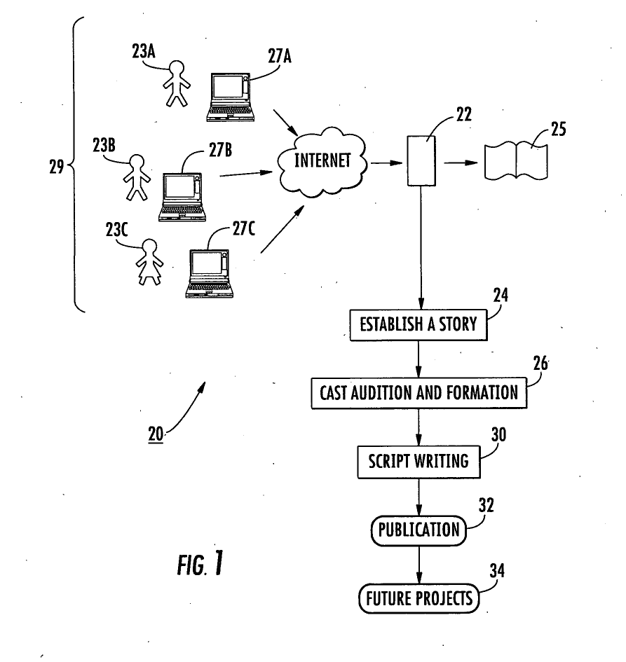

The present invention comprises an authorship cooperative system (ACS), generally indicated by reference number 20. Referring to FIG. 1, ACS 20 may be implemented on a server 22, a plurality of servers (not shown), or on one or a plurality of computers (not shown). In general, ACS 20 allows computer users 23A-C to gather and compose a piece of writing 25, such as a script for a play, a novel, a literary piece, and the like using their computers 27A-C. Essentially, ACS 20 allows the formation of a cooperative of authors 29.

With continued reference to FIG. 1, ACS 20 is preferably programmed to store, process, and execute the following protocols: establish at least one story 24, conduct an audition for authors and form a cast of authors 26, and allow the cast to create a composition 30. ACS 20 may include a program that allows the cast to choose whether or not to publish the composition 32. It is noted that the cast may be temporary, semi-regular, or regular. Temporary cast members may be given an opportunity to write and complete a script for a role for only one scene. Semi-regular cast members may be given an opportunity to write and complete a script for a role for more than one scene. For instance, the semi-regular cast member may write the script for a role for the entire theme. Regular cast members may be given the opportunities for semi-regular cast members and more, such as an opportunity to serve as authors for future projects. ACS 20 may include programs that allow regular cast members to engage in future projects 34.

It is noted that, as with any flowcharts presented and discussed herein, the order in which the steps are presented does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the scope of the invention.

Establishment of a Story

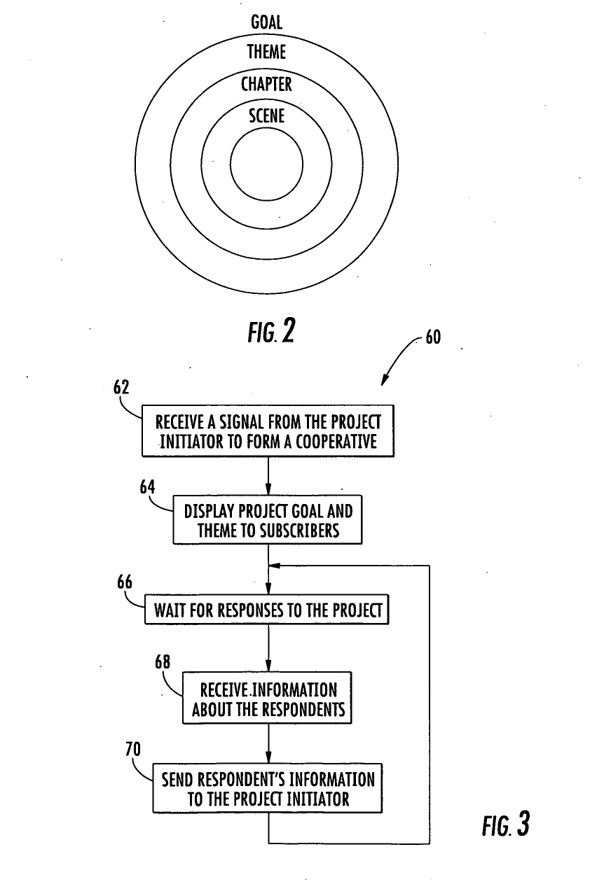

Referring now to FIG. 2, ACS 20 preferably allows a project initiator (not shown) to set at least one project goal 36. The project goal 36 may be to compose a play, movie script, music, or any other literary work. Within each project goal 36, a project theme 38 may be included. For instance, the project initiator may set a project goal that is to compose a movie script, and the project theme for the movie script may be a “Rags to Riches” theme, which involves portraying the life of a person who once lived a life in poverty and who experiences substantial financial success.

The source of project themes may be provided. For example, the source may be news, politicians, celebrities, biographies, historical events, and the like. The project themes may be categorized. For instance, one category may be inspirational, which may include biographies of successful people or news of how a group of people recovered from a calamity or disaster. Another category may be love story, which may include various stories of how celebrity couples met and fell in love. Yet another category may be drama, which may include the rise and fall of politician's political career or a story of family during a period of a major war.

The project theme 38 may be divided into a plurality of chapters, which may represent stages of the story. For each chapter, an alternative chapter may be provided. Each chapter may further be divided into scenes. Alternative scenes may also be provided. Each scene and alternative scene preferably has a list of predefined roles.

In the preferred embodiment, the project initiator may provide a project goal and a project theme, which may be stored in the server 22. The server 22 may send an invitation to subscribers to audition for a role and to fill-in the script for the scenes according to the role they will be assigned. ACS 20 includes programs for conducting said auditions.

Next, the server may execute a program, such as the programs described below, for conducting an audition where the roles are assigned to the subscribers. Once the roles are assigned, the subscribers can write the scripts according to their roles. The resulting literary work will therefore be a product of the subscribers' independent contributions.

In another embodiment, ACS 20 may include built-in templates of project goals and project themes. The project initiator may select from the templates at least one project goal and at least one project theme. The server 22 may notify subscribers of available roles for a particular theme. The server 22 may also send invitations to subscribers to select a role and audition for the role. Next, the server may execute a program, such as the programs described below, for assigning the roles to the subscribers. Once the roles are assigned, the server may provide the subscribers templates of scripts. The subscribers may compose scripts for their respective roles using the templates. Thus, the resulting literary work will be a product of the subscribers' selection and organization of templates.

Audition for Temporary Cast

ACS 20 preferably includes a program that invites authors or internet users to participate in fulfilling a project goal set by a project initiator. With reference to FIG. 3, a public invitation protocol 60 is shown wherein the invitation is made preferably to computer users whom the server has not had any prior contacts or dealings. The invitation is preferably to take on a single role and to write the script for that single role. Thus, the cast member will participate on a temporary basis.

Beginning at step 62, the server may receive a request signal from the project initiator to form a cooperative. At step 64, the server preferably displays the project goal and theme of the initiator (collectively referred to as “the invitation”) to internet users or subscribers. At step 66, the server preferably waits to receive a response from interested subscribers. Once a subscriber responds to the invitation, the server preferably obtains the subscriber's information (step 68) and forwards said information to the project initiator (step 70). The protocol may loop back to step 66 to gather more respondent information.

Coordinating the Potential Cast Members

Once the invitations are sent to the potential cast members (hereinafter referred to as “PCMs”), it is possible to receive many responses from invitees and find a plurality of qualified cast member for a particular role. The present invention includes a program that manages and coordinates the PCMs so as to avoid missing valuable talents of any PCM. In the preferred embodiment, the present invention includes a program that schedules the scenes and rolls over the scenes based on the schedule. Rolling over the scenes means allowing a single scene to be performed by a plurality of groups or a plurality of teams of cast members, and thus resulting in a plurality of compositions. It is noted that by rolling over the scenes, the server is able to gather a plurality of compositions from which a high quality composition can be picked.

The present invention further includes at least one program that queues PCMs according to a priority system. The priority system may be based on the PCM's availability for a particular schedule. The present invention may further include a notification system that preferably automatically alerts the PCM of an assigned role, and thus saves the PCM from having to regularly check the server for an assigned role.

In a preferred implementation of a program that queues PCMs based on the availability of the PCMs, each scene is preferably associated with a date and time for which the scene may be “performed.” That is, each scene is preferably assigned a performance schedule that notifies authors of the limited date and time when the authors may write scripts for the scene. A plurality of performance schedules may be assigned for a single scene. For instance, performance for scene 1 may be scheduled on a particular month, date, and year from 9 a.m. to 10 p.m. and 12 p.m. to 1 p.m. A full schedule may be available for subscribers to view, such as the schedule in the following table:

| Schedule for | |
|---|---|
| Jan. 10, 2004 | |
| Time | Scene |
| 9:00-10:00 a.m. | Scene 1 |
| 10:00-11:00 a.m. | Scene 2 |
| 11:00-12:00 p.m. | Scene 3 |
| 12:00-1:00 p.m. | Scene 1 |
| 12:00-1:00 p.m. | Scene 4 |
| 1:00-2:00 p.m. | Scene 2 |
| 1:00-2:00 p.m. | Scene 5 |
| 2:00-3:00 p.m. | Scene 3 |
| 3:00-4:00 p.m. | Scene 4 |
| 4:00-5:00 p.m. | Scene 5 |

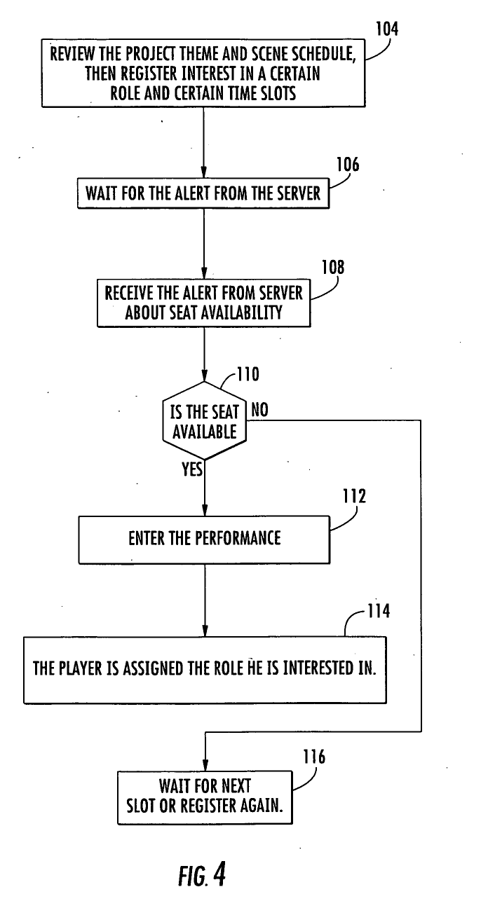

Referring now to FIG. 4, PCM preferably reviews the project theme and the schedule for each scene (step 104). The PCM may also identify the desired role and schedule (step 104). At step 106, the PCM preferably waits for a notification from the server about the availability of the role and schedule (hereinafter referred to as “seat”) the PCM has identified. Once the PCM receives the notification (step 108) and the PCM's desired role and schedule is available (step 110), the PCM is allowed to enter the performance (step 112). The PCM is then assigned the role he or she picked (step 114). If the PCM's desired role and schedule is unavailable, the PCM is preferably required to either wait for the next scene schedule or register his or her alternate desired role and schedule (step 116).

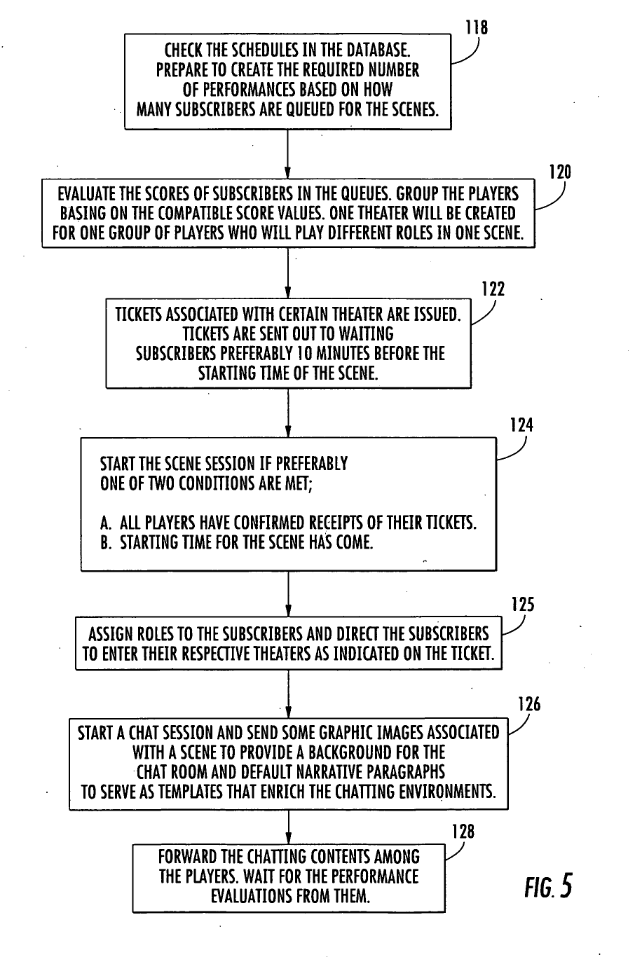

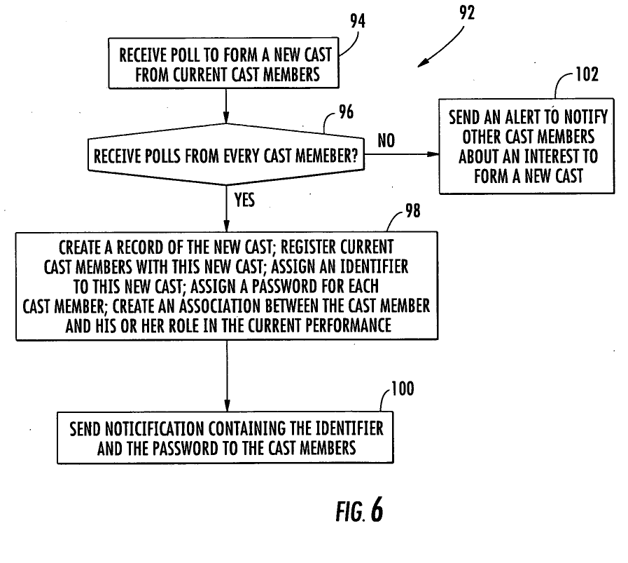

FIG. 5 shows the activities preferably executed by the server in coordinating the PCMs preferably prior to a performance. At step 118, the server checks the schedules preferably listed in a database. The server also determines how many performances to create based on the number of queued PCMs. Next, the server preferably evaluates the scores of the PCMs in the queue (step 120). For every role and for every schedule, the PCMs may pick the top PCM having attained the highest score from prior performance. The PCMs that were picked constitute a group for a particular performance or theatre. It is noted that step 120 may be skipped in some situations, such as when the number of seats are adequate to accommodate all the PCMs or when the PCMs have no prior performance record. It can be appreciated that step 120 a tool for grouping a large pool of PCMs. Step 120 may also provide a tool for matching PCMs based on their performance records so that PCMs with same or similar level of talent may be joined, which may create a challenging and encouraging atmosphere for the selected authors and may result to a high quality literary work.

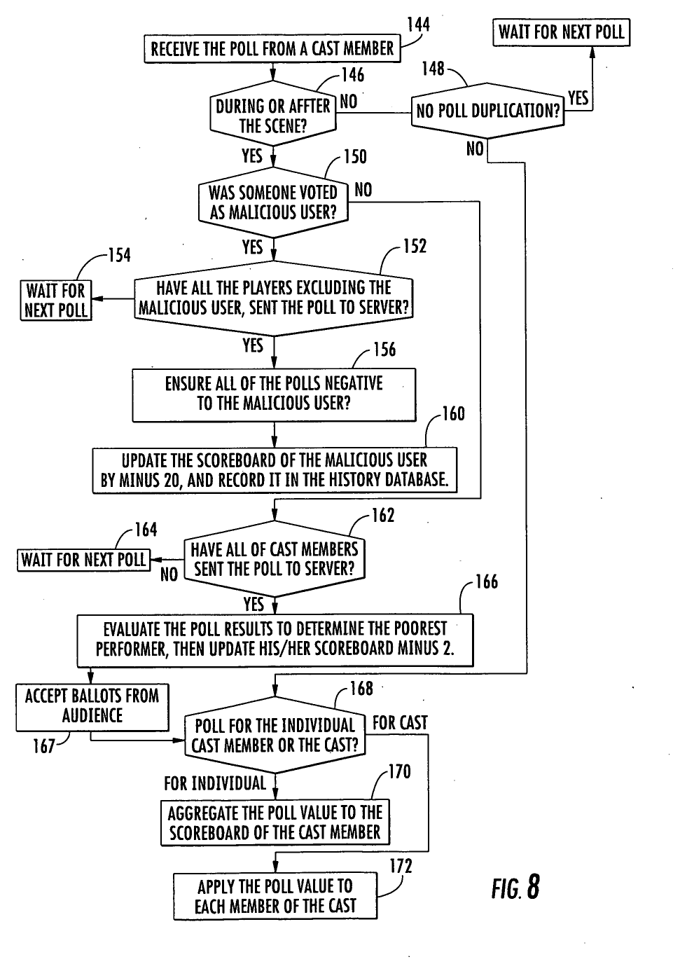

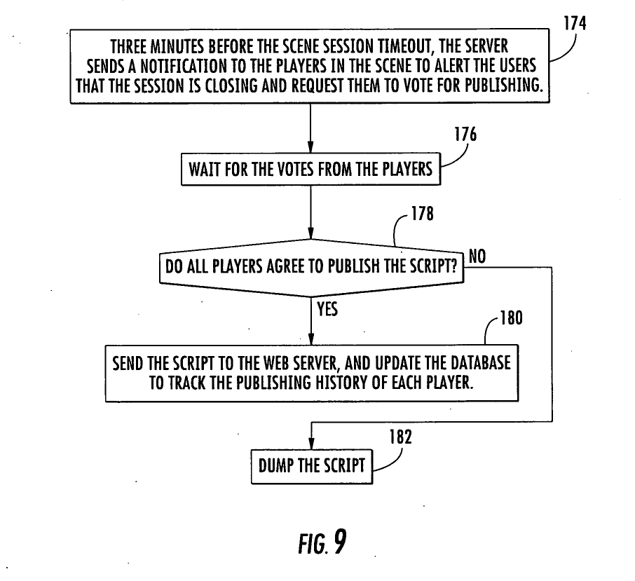

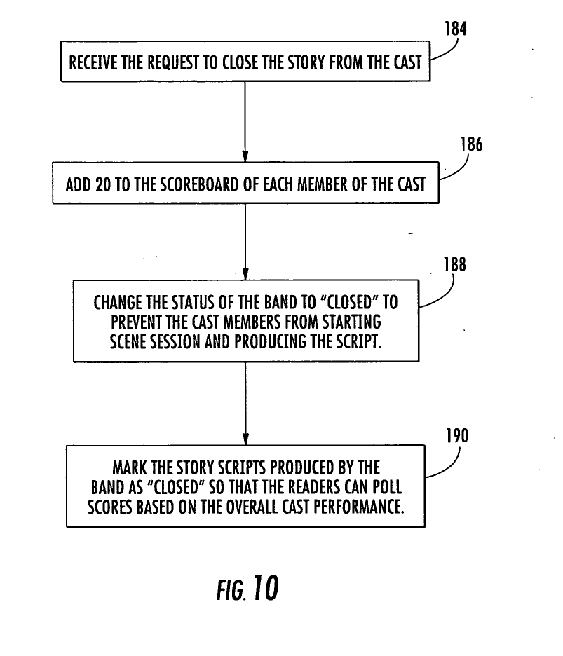

With continued reference to FIG. 7, at step 122, the theatre is preferably associated with a ticket. The term “ticket” is used to refer to a form of access given to a selected cast member. The ticket serves as a notification to the PCM whether he or she has obtained the role at the schedule he or she desired. Preferably, the tickets are sent out 10 minutes before the starting time of the performance. Various conditions and procedures may be used in sending out the tickets.

At step 124, before the server starts the performance, the server preferably waits for either the starting time of the performance or the receipt of tickets from all the players in a particular group. Once the starting time is reached or all tickets are received, the server assigns the roles to the PCMs and direct the PCMs to enter their respective theatres as may be indicated on their tickets 125. Next, the server preferably starts a chat session between the PCMs selected to be in the group (step 126). The selected PCMs may, as example, write a dialogue, which may be utilized as a script. Scenes may be developed from the dialogues, and the dialogues may be grouped to form the chapters. The server may display background information about the project theme, the chapters, and the scenes. At step 128, the server preferably forwards the chatting contents among the cast members. The server may also receive cast member performance evaluations from the cast members.

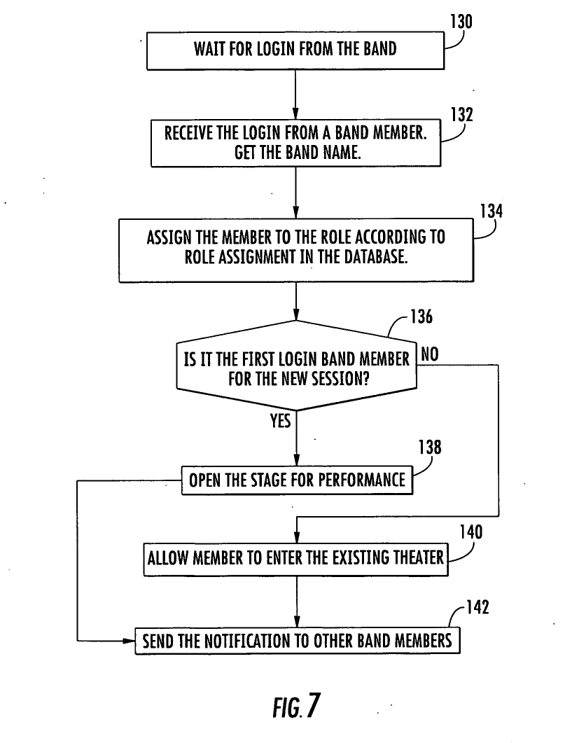

The protocols in FIGS. 4 and 5 are preferably applicable for coordinating potential cast members who may become temporary cast members. The temporary cast members may compose scripts for a role for a particular scene. Once the temporary cast members complete the scripts for their roles in the scene, their involvement in the project preferably ceases, unless they initiate the protocols described below for forming semi-regular or regular casts. It is noted that if the temporary cast member does not initiate said protocols and decides to participate again, the temporary cast member preferably has to audition again preferably through the audition protocol shown in FIG. 6 or FIG. 12 discussed below, and the temporary cast member has to be coordinated with other PCMs preferably through the protocol described in FIGS. 4 and 5. In contrast, if the temporary cast member initiates the protocols described below for forming semi-regular or regular casts and the semi-regular or regular cast is formed, the temporary cast member, who becomes either a semi-regular or a regular cast member, may only need to log in using an assigned name and password to continue working.

Initiating the Formation of Semi-Regular and Regular Cast

Semi-regular cast members are preferably given an opportunity to write and complete a script for a role for more than one scene. Regular cast members are preferably given the opportunities for semi-regular cast members plus an opportunity to serve as authors for future projects. With reference now to FIG. 6, a program 92 configured to allow performing cast members to invite fellow cast members to work past one scene is shown. Beginning at step 94, the processor preferably interrogates any input from cast members requesting to form a new cast for a different scene or a different project. At step 96, the processor checks to see if all of the current cast members express interest in forming the new cast. If less than all of the current cast members expressed interest in forming the new cast, the processor sends a notification to performing cast members about this new request to form a new cast for a different project (step 102).

Once all of the cast members expressed interest in forming the new cast, the processor preferably creates a cast record in a database, registers the current cast members with this new project, and assigns a password and a unique default cast name (step 98). The default cast name can be changed, if desired. The processor may further create an association between the cast members and the assigned role in the current session in step 98. At step 100, the processor sends a notification and the cast default name and password information to the cast members. Each cast member may simply use their respective default name and password to work on the new project. It is noted that since the cast members have worked together previously and they have expressed their desires in working together again, the cast members must have gained at least some confidence in each other. Thus, it can be appreciated that the system adapts to the increased confidence of the cast members toward each other by foregoing some steps in the audition process described above, which may include evaluating each cast member's prior performance before allowing them to enter the theater and perform. The cast members may simply use their password and identification to enter the theater for the next scene or theme.

Conducting the Performance

The detailed steps involved in conducting the performance will now be discussed. Once the proper cast members are gathered, the cast members may now perform to attain a goal, which is preferably to create a literary work in a collaborative manner. With reference now to FIG. 7, when the cast members are identified, the cast members may begin working on the project. Initially, the server preferably waits for login from the cast members (step 130). Whenever the server receives the login from a cast member, the server preferably obtains the group name or the project theme name (step 132). The server also assigns a role to the cast member preferably according to the role recorded in the database, which may be based on the preference the cast member initially indicated (step 134).

At step 136, the server determines whether this is the first ever login from any of the cast member of the project theme (step 136). If this is the first ever login, the server preferably opens the stage for performance for all the cast members (step 138). That is, the server provides the cast members with a fresh display of information and preferably instructions on how to use the system to collaborate on forming a composition. If this is not the first ever login, the server allows the cast member that is logging in to enter the current stage or performance (step 140). At step 142, the server preferably sends a notification to other cast members about the log in of a cast member.

When the cast members log in, the cast members preferably assume their respective roles. The cast members may chat among each other, and they may express their emotions by sending for example a small image, such as a smiling face. The server may store a plurality of small image templates that convey a plurality of expressions. On-line chat programs and discussion or forum like web applications may be used to facilitate the on-line discussion of the cast members. During the chat session, the cast members may exchange comments, ideas, and opinions about the theme, the scenes, and the roles so that the overall product can be a result of a true collaborative effort.

In the preferred embodiment, the publishing space is preferably organized using the following hierarchical structure—theme category/theme/cast/chapters/scenes/dates/scripts. As the cast members conduct a dialogue, their dialogue is preferably created into scripts and saved under the “scripts folder.” The cast may branch the theme and choose alternative chapters to be threaded into the theme. Preferably, each cast is restricted from making two scripts for a particular scene. The purpose is for the audience to easily comprehend the composition and evaluate the cast members accordingly.

It can be appreciated that the ACS allows cast members to pick their own performance schedule so long as they can coordinate their schedules. ACS further allows cast members to add new supporting roles into the theme; cast members can change their default narrative paragraphs; each cast member is provided his or her own publishing space so that the script each member creates can easily be threaded to create the composition. ACS preferably requires the cast to pick a theme from the list of themes or theme sources provided. The cast is preferably restricted from removing any role defined in the theme. These conditions may be removed, and other conditions may be added.

Assessment System

In the preferred embodiment, the present invention includes a system for assessing or evaluating the performance of each cast member. The assessment system may encourage the cast members to provide their best effort during the performance, as their scores will influence the likelihood of their work being published. Their scores will also influence each cast member's future participation in future projects. The assessment system may also help screen those who have ill intentions of destroying a performance (hereinafter referred to as “malicious users”).

The assessment system preferably includes the following set of ground rules. It is to be understood that these rules are not fixed. They may be modified and still fall within the spirit of the invention.
a. Chosen cast members automatically earn 100 points.
b. Each cast member is entitled to cast one ballot for each fellow cast member. A cast member cannot cast a ballot for himself or herself.
c. Ballots can only be cast during or after a scene.
d. Each ballot has the following scoring system:
   i. −20 for malicious user
   ii. −2 for the weakest performer
   iii. +1 for completing one scene without being voted as malicious user or weakest performer
   iv. +20 for each cast member whose cast published a composition
   v. −1 to +5, −1 being unsatisfactory and +5 being exceptional.
e. A cast member who has been voted a minimum of five times as malicious user will be denied access into the system.
f. After publishing a composition, the audience can cast a ballot. The limit is one ballot per audience. The audience can provide a score for each cast member's performance. The scores can range from −1 to +5, −1 being unsatisfactory and +5 being exceptional.
g. The audience can also score the performance of the cast as a whole. The scores can range from −20 to +20, −20 being unsatisfactory and +20 being exceptional. The score is preferably credited to each cast member.

With reference now to FIG. 8, the assessment system may be implemented in the following manner. Beginning at step 144, the server is preferably configured to receive ballots from cast members. The server is preferably configured to receive ballots only during or after the scene to allow users to vote off malicious users whose malicious intent may only be detected during or after performing a scene. At step 146, the server checks whether the ballot was cast during or after a scene. If the ballot was cast after the scene, the server ensures that no audience has voted more than once. If there was no poll duplication, the server preferably waits for the next ballot (step 149). If there was poll duplication, the server proceeds to step 168 discussed below.

If the ballot was cast during the scene, the server determines whether there was someone voted as malicious user (step 150). If there was someone voted as malicious user, the server ensures that only the cast members that were not voted as malicious user can cast a ballot (step 152). The server waits until all cast members eligible to vote have sent their ballots (step 154). Next, the server ensures that all of the polls are negative to the malicious user (step 156).

Once the server verifies that all the polls are negative to the malicious user, the score of the malicious user is preferably subtracted 20 points, and the updated score is recorded in the database (step 160). At step 162, the server preferably confirms that all eligible cast members have sent in their ballots. If not, the server continues to wait for the ballots (step 164). After receiving all the possible ballots, at step 166, the server preferably evaluates all the scores, determines the lowest score, and labels the cast member with the lowest score as poorest performer. The server preferably subtracts 2 points from the score of the poorest performer.

Next, the server is configured to accept ballots from the audience 167. Upon receipt of the ballot, the server sorts the ballots to see whether they are for evaluating an individual cast member or a cast's overall performance. The scores from the audiences' ballots are extracted. The server determines whether the ballot is for the cast or the individual member (step 168). If the ballot is for the individual cast member, the score from the ballot is applied to the individual cast member's score (step 170). If the ballot is for the cast, the score from the ballot is applied to the scores of each cast member (step 172). It is noted that alternate scoring systems may be implemented and still fall within the scope of the invention.

Publishing the Composition

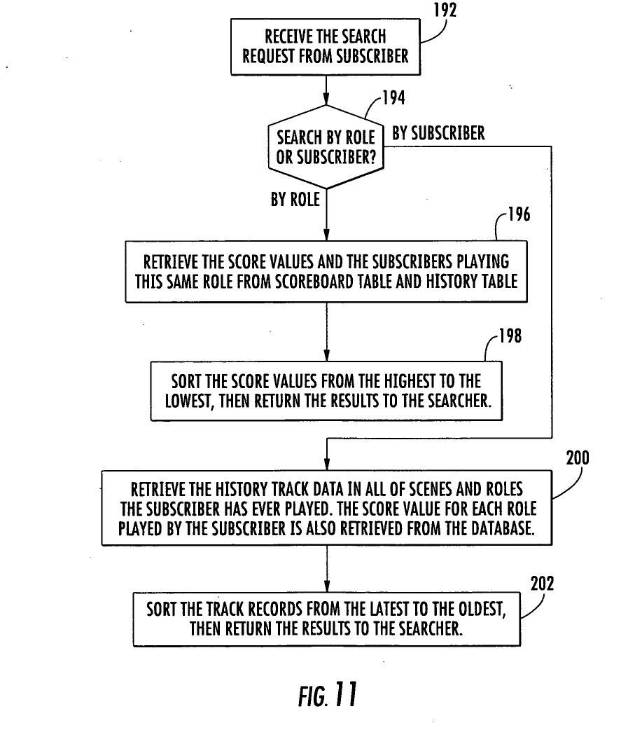

After the cast members have finished filling the scripts and ranking each fellow member's performance, the system preferably allows the cast to decide as a group whether to publish their composition. A session timeout is preferably provided, wherein the performance is scheduled to terminate by default. With reference now to FIG. 10, when the session timeout is about to be executed, the system preferably alerts the cast members three minutes before the session timeout that the session will be closing and that they need to cast the votes as to whether they want to publish the composition (step 174). Of course, other ways to configure the session time out may be used.

The server preferably waits for the cast members to cast their votes (step 176). Once the server receives all the votes, the server determines whether all the cast members agree to publish (step 178). If not all cast members agree to publish, then the server preferably dumps the composition (step 182). This rule can be flexible. For example, the server can require only a majority vote. The server may also save the composition so that the cast members are given another chance to improve the composition. If all the cast members agree to publish the composition, the composition may be sent to the web server (step 180), and the cast members' scores may be updated accordingly.

It is noted that a plurality of publishing places may be established. In the preferred embodiment, regular cast has a publishing space that is separate from the publishing space for the temporary cast. It can be appreciated that by having a plurality of publishing spaces, users may be allowed to convert scripts from the temporary casts' publishing space into story files located in the publishing space for regular casts over a period of time to create full stories.

Inactivity

In the preferred embodiment, the present invention includes a method of encouraging dynamic interplay between cast members. For instance, a protocol that closes the performance after ten days of inactivity may be implemented. Of course, inactivity may be defined in other ways foreseeable, such as lack of cast member input for several minutes, hours, or days or lack of new chapters made for a certain time period. Inactivity alert messages or messages that warn members of the termination of the performance may be provided.

Closing Procedure

A preferred closing procedure is shown in FIG. 10. At step 184, the server receives a signal to close the performance. The signal can be from the cast members or from protocols that were activated due to lack of inactivity. A score of 20 is preferably added to all the cast members' scores to encourage cast members to request the closure of the program at a first sign that the cast will not be effective (step 186). At step 188, the server preferably prevents cast members from adding any script or starting any performance. At step 190, the server preferably notifies the audience that the performance is closed so that the audience can cast their votes and the cast members' scores can be updated accordingly.

Future Cast Member Engagements

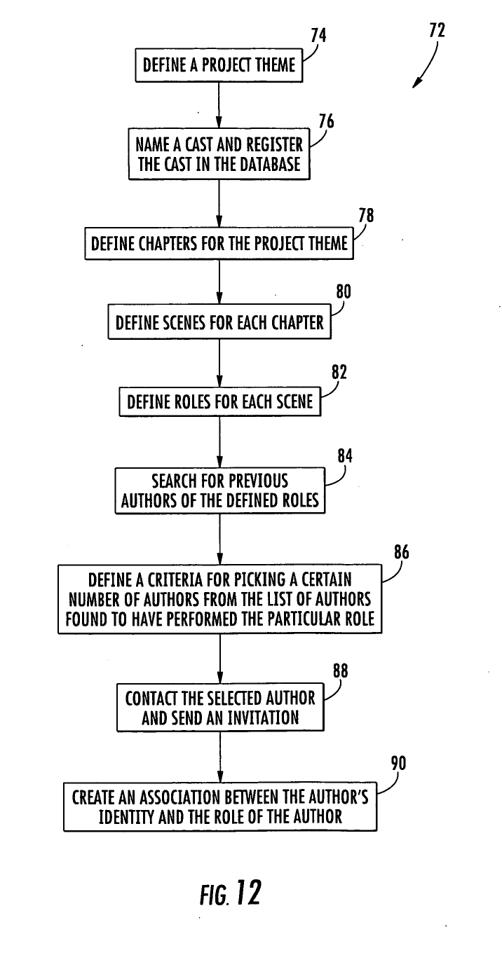

With the assessment system having the capability of tracking the history of a cast member's performance, cast members may have more opportunities to be involved in future projects. Cast members may be recruited by project initiators or casting directors who may recruit by using the cast member database. One way to implement a system that allows the search for a cast member using the database is shown in FIG. 11. At step 192, a searcher may send a search request to the server. Upon receipt of the request, the server preferably determines whether the search is by role or by cast member (step 194). If the search is by role, the server preferably finds the role, the respective list of cast members who have previously played the role and the individual scores of the cast members (step 196). The server may also rank the scores of the cast members in the list and may convey the ranked results to the searcher (step 198). If the search is by cast member, the server may produce a list of performances of the cast members with their respective scores (step 200). The server may arrange the list of performances in chronological order and send the list to the searcher (step 202).

The searcher may send a private invitation to the cast member from the search. Referring now to FIG. 5, a private invitation program 72 is shown. At step 74, the project initiator preferably defines a project theme. At step 76, a database of potential casts is created. The database preferably includes lists of previous cast members who have participated in collaboratively creating a composition. The chapters for the project theme are preferably defined at step 78, which may be executed by the cast or may already be built into the program. The corresponding scenes for each chapter may then be defined at step 80. Step 80 may also be executed by the cast or may already be built into the program.

From each scene, the roles are preferably extracted (step 82). At step 84, a processor (not shown) searches through a database (not shown) to match the predefined roles with any authors listed as having previously played the corresponding role. At step 86, a criterion for picking among the matching authors is defined. The criterion may utilize the assessment system discussed above, which is configured to rank the prior performance of each author and is further configured to use the ranking in assigning a role to the author. The processor uses the criteria to select among the matching authors. The selected authors are preferably sent an invitation using the author's contact information from the database (step 88). The invitation may include the name of the project theme, a password, and a meeting time. At step 90, the processor may create an association of the cast members' identity and their respective roles. The selected authors may use the password and cast member identity to login and begin working.

It can now be appreciated that certain embodiments of the present invention enable computer users to discover other computer users who can work with them to combine their diversified experience, skills, knowledge, and personal characters to produce a literary work. Certain embodiments of the present invention gather and record performance profiles of cast members. This database of performance profiles allows casting directors or project initiators to find cast members and obtain some indication of the performance capability of cast members. Casting directors may also determine the compatibility between cast members based on the cast members' prior performances.

It can further be appreciated that through certain embodiments of the assessment system, cast members self-regulate the conduct and performance of one another. Cast members are given the chance to back out of a role when they do not find compatibility among fellow cast members.

Although the description above contains many specifications, these should not be construed as limiting the scope of the invention but as merely providing illustrations of some of presently preferred embodiments of this invention. For example, the individual steps in implementing certain aspects of the invention do not have to be conducted in any one particular computer. The steps can be conducted on a personal computer, a public shared computer, a server, or on the combination of any of these computers. Certain log in procedures discussed above may also be eliminated. Thus, the scope of the invention should be determined by the appended claims and their legal equivalents rather than by the examples given.

1. A method of composing at least one literary work, the method comprising:
(A) establishing a story theme;
(B) providing a plurality of interconnected computers;
(C) allowing users to use the plurality of interconnected computers;
(D) forming a cast of authors from the users of the plurality of interconnected computers; and
(E) allowing the cast of authors to compose a script based on the story theme.

2. The method of claim 1, further comprising notifying the users about the story theme and inviting users to compose the script for the story theme.

3. The method of claim 1, further comprising allowing at least one cast member from the cast of authors to compose a script for a second story theme.

4. The method of claim 1, further comprising allowing at least one cast member to evaluate another cast member's performance.

5. The method of claim 4, further comprising:
(A) storing the evaluation of a cast member;
(B) providing a criteria for selecting a cast member for a second story theme, the criteria being based on the cast member's evaluation; and
(C) forming a cast for the second story theme using the criteria.

6. The method of claim 1, further comprising:
(A) subdividing the story theme into a plurality of roles;
(B) assigning at least one seat for each role;
(C) defining at least one performance schedule for each role;
(D) allowing a user to pick a role;
(E) allowing the user to define a preferred performance schedule; and
(F) assigning the seat to the user if the role and the role's corresponding schedule fit the user's selected role and schedule.

7. The method of claim 6, further comprising notifying the user of whether the user has been assigned a seat.

8. The method of claim 6, further comprising providing a plurality of performance schedules for at least one role.

9. The method of claim 8, wherein the number of performance schedules for each role is based on how many users indicated interest in performing the role.

10. The method of claim 8, further comprising
(A) allowing cast members to evaluate another cast member's performance by providing a performance score;
(B) storing the performance scores of the cast members;
(C) grouping the cast members according to their performance scores;
(D) providing a plurality of groups, each group comprising a plurality of cast members having score that fall within a pre-defined range;
(E) assigning different roles to at least two of the cast members of each group; and
(F) assigning a performance schedule to each cast member.

11. The method of claim 1, further comprising allowing cast members to monitor the performance of fellow cast members.

12. The method of claim 11, further comprising allowing at least one cast member to cast a vote indicating that a cast member is a malicious user.

13. The method of claim 1, further comprising allowing cast members to vote on whether to publish the script the cast has composed.

14. A system for cooperatively composing a literary work, the system comprising a plurality of interconnected computers including at least one central computer, the central computer being configured to:
(A) establish a story theme;
(B) form a cast; and
(C) allow the cast to write a script based on the story theme.

15. The system of claim 14, further comprising a computer program configured to allow the members of the cast to have a chat session, the contents of the chat session being configured to be transformed into the script.

16. The system of claim 14, further comprising a computer program configured to allow the members of the cast to evaluate each other, the evaluation information being configured to be usable for forming a cast for a second story theme.

17. The system of claim 16, wherein the computer program is further configured to allow at least one cast member to cast a vote that would at least initiate the disqualification of another cast member.

18. The system of claim 14, wherein the story theme comprises a plurality of roles, each role being configured to be performed multiple times, the system further comprising a computer program configured to assign prospective cast members to the plurality of roles.

19. The system of claim 14, further comprising a computer program configured to detect inactivity of the cast members and prompt the cast members about the inactivity.

20. A method of composing at least one literary work, the method comprising:
(A) providing a plurality of interconnected computers including at least one central computer;
(B) allowing users to use the plurality of interconnected computers;
(C) establishing a story theme, the story theme comprising a plurality of roles;
(D) inviting the users to assume at least one role and write a script for the role;
(E) allowing the users to respond;
(F) forming a cast by providing a criteria for assigning roles to the responding users; and
(G) allowing the cast members to compose scripts for the story theme.

21. The method of claim 20, further comprising allowing at least one cast member from the cast to invite another cast member to compose a script for a second story theme.

22. The method of claim 20, further comprising allowing at least one cast member to evaluate a cast member's performance.

23. The method of claim 22, further comprising:
(A) storing the evaluation of a cast member;
(B) providing a criteria for selecting a cast member for a second story theme, the criteria being based on the cast member's evaluation; and
(C) forming a cast for the second story theme using the criteria.

24. The method of claim 20, further comprising:
(A) assigning at least one seat for each role;
(B) defining a performance schedule for each role;
(C) allowing a user to pick a role;
(D) allowing the user to define a preferred performance schedule; and
(E) assigning the seat to the user if the role and the schedule fit the user's selected role and schedule.

25. The method of claim 24, further comprising notifying the user of whether the user has been assigned a seat.

26. The method of claim 24, further comprising providing a plurality of performance schedules for at least one role.

27. The method of claim 26, wherein the number of performance schedules for each role is based on how many users indicated interest in performing the role.

28. The method of claim 26, further comprising
(A) allowing cast members to evaluate other cast member's performance by providing a performance score;
(B) storing the performance scores of the cast members;
(C) grouping the cast members according to their performance scores;
(D) providing a plurality of groups, each group comprising a plurality of cast members having score that fall within a pre-defined range, each cast member from the plurality of cast members having played a role that is different from the roles played by the other cast members; and
(E) assigning the plurality of performance schedules to the plurality of groups.

29. The method of claim 20, further comprising allowing cast members to monitor the performance of fellow cast members.

30. The method of claim 29, further comprising allowing cast members to cast a vote indicating that a cast member is a malicious user.

31. The method of claim 20, further comprising allowing cast members to vote on whether to publish the script the cast has composed.

32. The method of claim 1, further comprising:
(A) allowing at least one cast member to invite at least one other cast member to contribute to a second theme;
(B) providing an access code to the inviting cast member and the invited cast member; and
(C) granting access to the inviting cast member and the invited cast member to write a script.

33. The method of claim 20, further comprising:
(A) allowing at least one cast member to invite at least one other cast member to contribute to a second theme;
(B) providing an access code to the inviting cast member and the invited cast member; and
(C) granting access to the inviting cast member and the invited cast member to write a script.
